(19) United States
(12) Patent Application Publication
(10) Pub. No.: US 2008/0199618 A1
(43) Pub. Date: Aug. 21, 2008

(54) Method of Strengthening a Brittle Oxide Substrate with a Weatherable Coating

(75) Inventors: Mei Wen, Malvern, PA (US); Jean-Michel Chabagno, Pau (FR); Gary S. Silverman, Chadds Ford, PA (US); Maurice Bourrel, Pau (FR); Thomas D. Culp, La Crosse, WI (US); Haewon Uhm, Manchester, CT (US); Linda Bruce-Gerz, Philadelphia, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 11/994,524

(22) PCT Filed: Jun. 28, 2006
(86) PCT No.: PCT/US06/25250

§ 371 Date: Jan. 3, 2008

Related U.S. Application Data
(60) Provisional application No. 60/697,136, filed on Jul. 7, 2005.

(51) Int. Cl. B05D 3/00; C08F 2/46

(52) U.S. Cl. 427/299; 522/182; 522/65

(57) ABSTRACT

The present invention relates to a method of strengthening brittle oxide pieces such as glass pieces with a siloxane-acrylate coating system that has superior weatherability, particularly hydrolytic stability. The coating system comprises a combination of a silane solution and a radiation-curable acrylate solution. The mixture is applied to a clean, brittle oxide surface. The silane solution comprises one or more silanes in a non-aqueous solvent and the radiation-curable acrylate solution comprises one or more acrylate or methacrylate monomers, acrylate or methacrylate oligomers, and initiators, such as photoinitiators.

### FIELD OF THE INVENTION

The present invention relates generally to methods of strengthening brittle oxide articles. More particularly, the present invention relates to a coating for brittle articles such as glass articles which provides a hydrolytically stable, strengthening coating on the article.

### BACKGROUND OF THE INVENTION

The present invention provides a method of strengthening brittle oxide substrates (e.g. window glass or glass containers) that have been weakened by surface or edge flaws such as when glass is cut by scoring and broken or when glass bottles are worn in handling. Coatings have been used to repair surface flaws in glass and thereby strengthening the glass towards the strength of unflawed glass. Particularly useful strengthening compositions are aqueous solutions containing silane-based compositions especially polymerized cross-linked siloxane. Use of silane-based treatments is limited by their lack of resistance to weathering or moisture degradation. The present invention relates to a method of strengthening or restoring strength to brittle oxide articles which is highly resistant to weathering or moisture degradation.

Articles made from brittle materials, such as glass window panes or glass containers; generally have substantially lower tensile strength than predicted. This weakening can be the result of such factors as imperfections in the article, or small amounts of impurities in either the body or the surface of the article, or flaws on the surface or the edges of the article. Historically many types of surface coatings of brittle material have been used to protect the surface from abrasion and damage.

Glass is intrinsically one of the strongest materials known to man. Theoretically, standard silicate glasses should be able to support stresses as high as 14 to 20 gigapascals (2 to 3 million pounds per square inch (psi)). In practice, however, the strengths typically obtained are on the order of 70 megapascals (MPa), about 10,000 psi.

The explanation of the discrepancy between predicted and measured values is the existence of surface flaws or cracks. These flaws essentially fracture the siloxane network (Si—O—Si), which is the backbone of the glass. The damaged point in the glass becomes the focal point of forces on the glass and acts to concentrate the force and cause catastrophic failure of the glass article, typically at much lower stresses than otherwise expected.

Flat glass is produced commercially by a “float” process that produces a wide continuous sheet of glass. The flat glass is often cut into more useful sizes. The cutting process introduces flaws into the edges of the glass. Cut flat glass pieces are often heat treated to increase strength through thermal tempering. Heat treatment or tempering is an expensive process. [MWI] Bottles or other glass containers are subjected to scratches and surface damage during filling, shipping and handling operations which introduce flaws.

Researchers have long sought a means to alleviate the problems with glass strength. Modifications to the forming and handling process of glass articles have been shown to provide for some increase in glass strength. However, the results are less than desired because the modified forming and handling procedures can actually introduce flaws into the glass articles. For this reason, it has been a goal of researchers to reduce the effect of flaws after they are inevitably formed on the object.

Heat strengthening or tempering creates compressive stress on a glass surface which strengthens the glass. This expensive method can lead to deformation of the glass surface. Chemical strengthening through ion-exchange is typically slow, resulting in unacceptable throughput. Neither heat strengthening nor chemical strengthening are able to maintain the strength upon damage to the glass (particularly in the weak regions) after strengthening. Such damage can significantly reduce the strength. Strengthening of glass with a polymeric coating has advantages over other more traditional ways of strengthening glass. The application of polymeric coatings is a more advantageous method to strengthen glass, as it is fast, protective, and can preserve the optical properties of the glass. Polymeric coatings can be applied to edges or surfaces of a flat sheet of glass, or to a curved surface such as the surface of glass containers.

Some approaches to improving the strength of glass include Aratani et al., U.S. Pat. No. 4,859,636, wherein metal ions in the glass are exchanged with ions of a larger radius to develop a surface compressive stress. Poole et al., U.S. Pat. No. 3,743,491 also relates to a surface ion treatment which is followed by an olefin polymer coating. Hashimoto et al., U.S. Pat. No. 4,891,241, relates to strengthening glass surfaces with the application and cure of silane coupling agents in conjunction with acryloyl and methacrylol compounds. Hashimoto et al., U.S. Pat. No. 5,889,074 relates to strengthening glass surfaces with the application and cure of a coupling agent such as silane, titanium, aluminum, zirconium and zirconium/aluminum in conjunction with an active energy ray curable compound such as a fluoroacryloyl, acryloyl and methacrylol and water. Carson et al., U.S. Pat. Nos. 5,567,235 and 6,013,333 disclose methods for strengthening a brittle oxide substrate with the application and cure of aqueous silane-based compositions.

While the patents described above each provide some improvement in the strength of the treated glass, they are not without limitations. Some may require polishing or thermal tempering which require longer times than available during manufacturing, necessitating off-line processing. Furthermore, the coatings described in the above patents are subject to degradation after a relatively short time upon being exposed to water and/or moisture. A major problem with earlier coating was the decrease in strength due to exposure to moisture and/or water.

### BRIEF SUMMARY OF THE PRESENT INVENTION

The present invention relates to a method of strengthening brittle oxide pieces such as glass pieces with a siloxane-acrylate coating system that has superior weatherability, particularly hydrolytic stability. The coating system of the present invention maintains the strengthening effect during prolonged exposure to moisture or high humidity conditions. The coating system comprises a mixture of a silane solution and a radiation-curable acrylate solution. The mixture is applied to a clean, brittle oxide surface. The silane solution comprises one or more silanes in a non-aqueous solvent and the radiation-curable acrylate solution comprises one or more acrylate or methacrylate monomers, acrylate or methacrylate oligomers, and initiators, such as photoinitiators.

### BRIEF DESCRIPTION OF THE DRAWINGS

FIG. 1 is a chart of strength versus treatment method.

FIGS. 2a and 2b are photomicrographs of coated glass after exposure to boiling water.

FIGS. 3a and 3b are photomicrographs of coated glass after exposure to boiling water.

FIGS. 4a-4c are photomicrographs of coated glass after exposure to boiling water.

FIG. 5 is a chart of strength versus silane type.

FIG. 6 is a chart of strength (before and after boiling water test) versus formulation.

### DETAILED DESCRIPTION OF THE PRESENT INVENTION

The brittle oxide substrate of the method of the present invention can be made of any brittle oxide material such as aluminate, silicon oxides or silicates, titanium oxides or titanates, germinates, or glass made from, for instance, the above materials. Further, the brittle oxide substrate can be of any form such as flat glass or a glass bottle. For flat glass, the coating may be applied to the flat surfaces, the edge surfaces, or both. For convenience, such brittle oxide substrates will be referred to herein as glass substrates. The coating system comprises applying a mixture of a silane solution and a radiation-curable acrylate solution to a clean glass substrate. The ratio of the silane solution to the acrylate solution depends on the solution viscosity, coating's thermal and mechanical properties after drying and curing, and coating's adhesion to glass. Preferable the ratio ranges from about 1 to 50 to 5 to 1.

The silane solution component of the present invention may consist of a silane coupling agent dissolved in a non-aqueous solvent. The non-aqueous solvent can be any typical solvents that are compatible with the silanes and acrylates used such as ethanol, isopropanol, butanol, furfuryl alcohol, tetrahydrofuran, dioxane, diethyl ether, acetone, methylethylketone, methylisobutylketone, diethyl ether, methyl acetate, ethyl acetate, toluene, carbon tetrachloride, chloroform, n-hexane, dimethylformamide, and N-methyl-2-pyrrolidone. The silane coupling agent is preferably selected from the acrylate and methacrylate functional silanes and vinyl functional silanes such as γ-methacryloxypropyl-trimethoxysilane, γ-acryloxypropyltrimethoxysilane, γ-acryloxypropyltriethoxysilane, methacryloxypropyltriethoxysilane, methacryloxymethyltriethoxysilane, methacryloxymethyltrimethoxysilane, vinyltrimethoxysilane, vinyltriethoxysilane, vinyltris(2-methoxyethoxy)silane, vinyltriisopropoxysilane, vinyltriacetoxy silane, allyltrimethoxysilane, allyltriethoxysilane, or mixtures of such silane coupling agents.

The addition of polyalkoxyfunctional silane crosslinkers having four or more alkoxy groups in combination with the silane coupling agent is believed to provide for more highly crosslinked siloxane networks. The addition of polyalkoxyfunctional silane crosslinker including bis(triethoxysilyl)ethane, bis(trimethoxysilyl)ethane, tris(trimethoxysilylpropyl)isocyanurate was found to enhance the hydrolytical stability of the coatings. Other polyalkoxyfunctional silane crosslinkers that can be used include but not limited to bis(triethoxysilyl)methane, bis(trimethoxysilyl)methane, bis(trimethoxysilyl)propane, bis(triethoxysilyl)propane, bis(trimethoxysilyl)hexane, bis(triethoxysilyl)hexane, bis(trimethoxysilyl)octane, bis(triethoxysilyl)octane, bis(triethoxysilyl)ethylene, bis(trimethoxysilylmethyl)ethylene, bis(trimethoxysilyl)benzene, bis(triethoxysilyl)benzene, bis(trimethoxysilylethyl)benzene, bis(triethoxysilylethyl)benzene, bis(tirmethoxysilylpropyl)fumarate, bis(tirethoxysilylpropyl)fumarate, bis(trimethoxysilylpropyl)amine, bis[3-trimethoxysilyl)propyl]ethylenediamine, 1-(triethoxysilyl)-2-(diethoxymethylsilyl)ethane, tetraethoxysilane, tetramethoxysilane.

The ratio of silane coupling agent to polyalkoxyfunctional silane crosslinker can range from about 1:2 to about 10:1. Preferably, polyalkoxyfunctional silane crosslinker is added to the silane coupling agent in a ratio of silane coupling agent to the crosslinker of about 1:1. A small amount of water is typically added to the silane solution to promote the hydrolysis of the silanes. Preferably, the molar ratio of water to hydrolysable groups in the silane coupling agent and the polyalkoxyfunctional silane crosslinker is in the range of 1 to 3 to 4 to 1. The water is preferably adjusted to a pH value of pH=3-4, or 10-11 to catalyze hydrolysis and condensation. The pH of the water is preferably adjusted with acids such as acetic acid, sulfuric acid, or bases such as ammonia, sodium hydroxide, potassium hydroxide. Aging of the silane solution before mixing with acrylate solution for 5 minutes to one month is used to promote prehydrolysis of silanes. Preferably, the aging time is within 5 minutes to one day.

The total silane (silane coupling agent plus polyalkoxyfunctional silane crosslinker) concentration in the dried coating of the present invention can range from about 1% to 10% by weight of the coating combination.

The radiation-curable acrylate solution component of the present invention can comprise acrylate or methacrylate monomers, acrylate or methacrylate oligomers, and initiators such as photoinitiators and/or thermal initiators. The acrylate or methacrylate monomers and oligomers can have different functionalities to adjust viscosity, crosslink density, and the mechanical properties of the coatings. Suitable monomers include, but are not limited to, isobornyl acrylate, 2-hydroxyethyl methacrylate, 1,6-hexanediol diacrylate, polyethylene glycol 600 dimethacrylate, ethoxylated 2 bisphenol A dimethacrylate, trimethylolpropane triacrylate, tris(hydroxyethyl)isocyanurate triacrylate, di-trimethylolpropane tetraacrylate, pentaerythritol triacrylate, pentaerythritol tetraacrylate, etc. Suitable oligomers or oligomers mixed with some acrylate or methacrylate monomers include, but are not limited to aliphatic urethane acrylate oligomers Ebecryl 284, Ebecryl 8402 (both available from UCB Chemicals), CN982B88, CN963A80, CN963B80, CN963E80, CN963J85, CN964, CN964A85, CN964B85, CN985B88 (each available from Sartomer), and aliphatic urethane methacrylate oligomer CN1963 (available from Sartomer). Methacrylates typically react slower than acrylates so UV curing can take longer and/or require higher dosages or more irradiations pass to achieve a tacky-free surface cure.

Initiation of the polymerization in the functional groups in the silane component and the acrylate component can be via any acceptable method including but not limited to light (UV) curing, heat curing and electron beam curing. Photoinitiation via UV light or heat-induced initiation is preferred. Photoinitiation is implemented by incorporating one or more suitable photoinitiators into the combination. The photoinitiators are designed to absorb UV light in specific wavelengths and should be selected such that the absorbed light wavelength overlaps with the emission bands of the light source used to initiate the reaction. The photoinitiators are preferably incorporated into the acrylate component of the combination. Examples of suitable photoinitiators, include but are not limited to 2-hydroxy-2-methyl-1-phenyl-1-proponane (Darocur 1173, available from CIBA), ethyl(2,4,6-trimethylbenzoyl)phenylphosphinate (Lucirin TPO-L, available from BASF), phenylbis(2,4,6 trimethylbenzoyl)-phenylphosphineoxide (Irgacure 819, available from CIBA), and 1-hydroxycyclohexylphenyl ketone (Irgacure 184, available from CIBA). Heat-induced initiation can be implemented by incorporating thermal initiators into the combination. Examples of suitable thermal initiators, include but are not limited to organic peroxides such as Lupersol 231, t-butyl perbenzoate, Lupersol 256, Lupersol 80, Lupersol 575, t-butyl peroctoate, Lupersol TBIC (each available from Arkema, Inc). When electron beam curing is applied, no photoinitiators or thermal initiators are needed.

Optionally, hindered amine light stabilizer can be added to the coating combination to enhance the stability of the coatings to sunlight or UV light damage. Examples of effective hindered amine light stabilizers include, but are not limited to, Tinuvin 292 (available from CIBA) and Tinuvin 123 (available from CIBA).

Optionally, inorganic particles (e.g., micro- or nano-size silica particles) can be added to the coating to increase the strength of the coating. When the inorganic particles are small (e.g., nano-particles), they also serve as thixotropic agents. The particles can be treated with acrylate or methacrylate functional groups, or hydrophobic groups. Examples of such particles include treated fumed silica such as Aerosil R 711 (available from Degussa Corp), Aerosil R 7200 (available from Degussa Corp) and CAB-O-SIL 530 (available from Cabot Corp).

In the examples, for coatings on glass surface, the coating solution was applied to soda-lime-silica glass on the non-tin side of the surface. A tin coating on one side of float glass is the result of the tin based surface the molten glass is formed on. Indented glass was also used to create a controlled flaw on the non-tin side of the surface for strengthening studies. A Vickers micro-indenter was used to create a flaw approximately 4 microns deep and approximately 41 microns wide in the center. Both indented and non-indented glass were pretreated with a cleaning regime and dried. The coating was then applied to the glass flat surfaces with a blade coater on the non-tin side.

For coatings applied to glass edges, the glass used was soda-lime-silica glass cut by hand using a 130 metal scoring wheel, scoring on the non-tin side. The standard size of glass in edge strengthening studies was 1 in×6 in×2.2 mm. The glass was pretreated with a cleaning regime and dried. The strengthening solution was applied along the long edges of the samples by a motored, “V” shape roller applicator.

The glass samples were cleaned with either (1) a commercial detergent glass cleaner (Windex® available form S.C. Johnson & Son) followed by an isopropanol rinse and air drying or (2) soaking in a saturated potassium hydroxide/isoproponal solution, rinsing with deionized water, soaking in 10 wt % sulphuric acid, rinsing with deionized water, soaking in deionized water, and blowing dry with clean air or nitrogen (potassium hydroxide/acid cleaning). It was found that the glass cleaning with a commercial detergent glass cleaner did not provide a thoroughly clean surface and adhesion (particularly wet adhesion) of the later applied coating was not strong. The preferred cleaning method was the second procedure described above which provided a thoroughly clean, slightly etched and hydroxylated glass surface that allowed for enhanced adhesion, particularly wet adhesion, of the applied coating. Other cleaning methods that can generate a clean, roughened, and/or hydroxylated surface can also be used.

After the application of a coating, the coating was cured either by thermal cure, ultraviolet light cure or a combination of both. It was found that a thermal cure followed by a UV light cure enhanced the strengthening effect of the coating combination of the present invention. A thermal cure to a temperature of between about 110° to 170° C. for from 10 seconds to 30 minutes followed by a UV light cure is preferred. For coatings on glass surface, a thermal cure at about 120° C. in an oven for about 10 min followed by ultraviolet (UV) curing was applied for the test panels. The UV curing was via a 184 watt/cm doped mercury vapor lamp to obtain a tacky-free surface. UV light was irradiated directly on the coating surface. For coating on each glass edge, infrared panels were used to heat each glass edge (less than 1 minute) to reach a surface temperature of 120-140° C. Then the coating was cured by UV irradiation via a 184 watt/cm doped mercury vapor lamp to obtain a tacky-free surface. UV light was irradiated directly onto the coated edge. Preferred curing times and temperatures will vary with the type of brittle oxide, and the specific equipment employed.

Glass strength with cured coatings as well as control (non-coated glass) was tested by a ring-on-ring test for surface coated glass and a four-point bending test for edge coated glass respectively.

In the ring-on-ring test, the samples were taped on their non-indented sides to retain glass fragments after breakage. During measurement, the indented side was put with its face down and supported by a supporting ring 35 mm in diameter. A steel punch with a diameter of 14 mm was moved in a speed of 0.5 mm/min until the sample underwent brittle failure. The modulus of rupture (MOR) or the strength of the glass was calculated. The ring-on-ring, or concentric ring strength testing was as described in the Journal of Strain Analysis, Vol. 19, No. 3 (1984) and the Journal of Non-Crystalline Solids, 38 & 39, pp. 419-424 (1980). This test is commonly recognized by those skilled in the art.

In the four-point bending test, the load span/thickness ratio was maintained at 31.6 for glass samples with different dimensions. The ratio of load span to support span was kept at 1:1.375. A strain rate of 1×10⁻⁵s⁻¹ was used. This was used to calculate the actual load rate applied. This arrangement placed the bottom surface of the sample under uniform tension and the top surface under uniform compression between the two load points. Because the scored edge represents the weakest part of the glass, samples were mounted with the scored edge downward under tension. The top surface was taped to prevent flying of glass chips. The tensile strength or modulus of rupture (MOR) was the tensile stress at which the sample underwent brittle failure, which was calculated from the maximum applied load before breakage. All failures originated from flaws at the sample edges.

To determine coating's hydrolytical stability, coated samples were tested in a boiling water test in which the coated glass substrates were immersed in boiling water for a predetermined period of time, removed, dried and cooled to room temperature. Coating delamination and macroscopic cracking were checked. An optical microscope was used to observe blister and/or other defect formation. Besides the optical imaging analysis, ASTM D3359-02, method A, X-cut tape test was also used to evaluate the wet adhesion in some cases. In addition, strength measurement was also carried out on boiling-water treated samples in some cases.

To further determine coating's weatherability, QUV accelerated weathering test and a thermal cycling/humidity test that mimicked ASTM E773/E774 test were carried in some coated samples. Coating defects and/or strength measurement were carried out after a certain period of weathering test.

The present invention will be further clarified by the following examples, which are intended to be purely exemplary of the present invention. All percentages used herein are by weight unless otherwise specified.

### EXAMPLES

### Example 1

A coating combination comprising a combination of a silane component comprising the silane coupling agent, gama-methacryloxypropyltrimethoxysilane 3% and the polyalkoxyfunctional silane crosslinker bis(tri-ethoxysilyl)ethane 3% in isopropanol solvent 13% with an acrylate component comprising the acrylates: urethane acrylate oligomer plus 1,6-hexanediol diacrylate (Ebecryl 284, the ratio of urethane acrylate oligomer to 1,6-hexanediol diacrylate is 7.33:1) 30%, tris(2-hydroxylethyl)isocyaurate triacrylate 28% and isobornyl acrylate 17% with photoinitiators 2-hydroxy-2-methyl-1-phenyl-1-proponane 1% and ethyl(2,4,6-trimethylbenzoyl)phenylphosphinate 4% was prepared. The ratio of total silane solution to total acrylate solution on a weight basis was 1 to 4. Water 1% adjusted to pH=4 with aqueous acetic acid was added to the silane component to catalytically hydrolyze the silanes. Before mixing the silane solution with the acrylate solution, aging of the silane solution for 4 hours was applied. The coating combination was applied to flat, indented glass test panels via a blade coater to provide a coating thickness of 100 microns. The glass panels were first cleaned by either (a) a commercial glass cleaner (Windex® available form S.C. Johnson & Son) followed by an isopropanol rinse and air drying or (b) soaking in a saturated potassium hydroxide/isopropanal solution for 16 hours, rinsing with deionized water, soaking in 10 wt % sulphuric acid for 15-30 minutes, rinsing with deionized water, soaking in deionized water for 20 minutes and blowing dry with clean air or nitrogen (potassium hydroxide/acid cleaning).

FIG. 1 shows the glass strength tested via a ring-on-ring test. A control or untreated, indented glass panel was also tested. The data shows an increase in strength is provided by coating combinations in accordance with the present invention for both cleaning regimes, with the “potassium hydroxide/acid” cleaning regime providing for the highest strength.

### Example 2

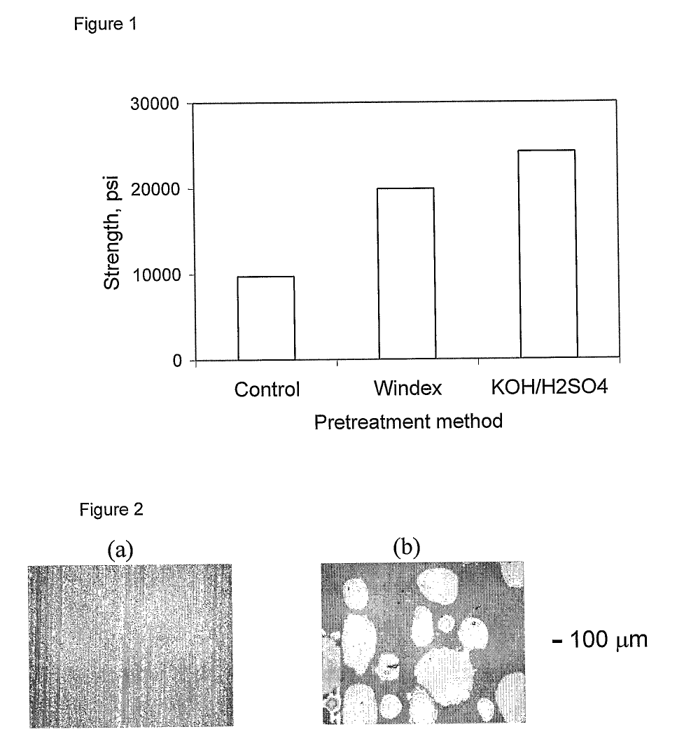

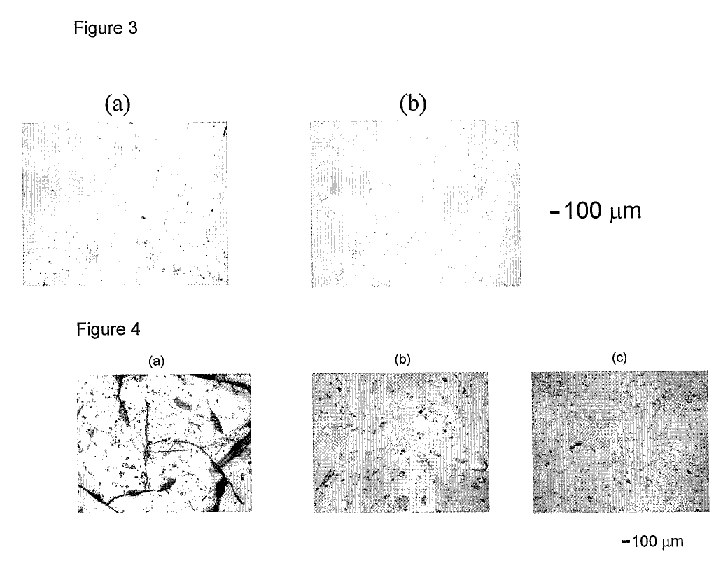

Non-indented, flat glass test panels cleaned with the “potassium hydroxide/acid” cleaning regime and coating in accordance with example 1 were subjected to boiling water testing to evaluate the hydrolytical stability of the coating. The coating thickness was 70 microns. Cleaned and coated glass panel were immersed in boiling water for 1 hour, examined, and then immersed for an additional 3 hours. Optical microscopy was used to examine for blister and other defect formation. X-cut tape test (ASTM D3359-02 method A) was also used to evaluate the wet adhesion. FIGS. 2 and 3 show photomicrographs of the glass panels after boiling water immersion. As can be seen, after one hour immersion (FIGS. 2a and 3a) the glass panel cleaned with a commercial glass cleaner began to show blistering and the adhesion rating dropped to 1 A. Whereas glass panels cleaned with the potassium hydroxide/acid process did not show any blister formation and the adhesion rating remained at 5 A. After the additional three hours immersion (FIGS. 2b and 3b), the glass panel cleaned with a commercial glass cleaner form bigger blisters and the coating totally lost adhesion to the substrate. In contrast, the glass panel cleaned with the potassium hydroxide/acid process did not show any blisters and the adhesion rating remained at 5 A. The glass panels cleaned with the potassium hydroxide/acid process described above provided perfect adhesion of the coating, i.e., no blistering and 5 A measured adhesion, after more than 100 hours in the boiling water immersion test.

### Example 3

Flat glass test panels cleaned with the “potassium hydroxide/acid” cleaning regime and coating in accordance with example 1 were subjected to QUV accelerated weathering testing comprising exposure to continuous deionized water spray at 60° C. (100% humidity) and UVA-351 exposure with 0.25 W/m²/nm light intensity and strength was tested with the ring-on-ring test. The coating thickness was 70 microns (Sample 1) and 30 microns (Sample 2) respectively. Table 2 summarized the strength before QUV test. Included are Control 1 for indented non-coated glass panels and Control 2 for indented, non-coated, cleaned glass panels. The results are averages for 9 replicate tests. In the QUV high humidity testing, the coated test panels with Sample 1 began to show blistering at about 6 days and delamination at about 5-9 weeks, whereas the coated test panels with Sample 2 began to show blistering at about 4 days and delamination at about 4-7 weeks.

TABLE 2
Strength Testing

| Test system | Control 1 | Control 2 | Sample 1 | Sample 2 |
|---|---|---|---|---|
| Note | indented, | indented, non- | indented glass | indented |
| | non-coated | coated, cleaned | 70-micron | glass |
| | glass | | coating | 30-micron |
| | | | | coating |
| Average of | 8256 | 8490 | 27608 | 26101 |
| strength, psi | | | | |
| Strength | — | 3% | 234% | 216% |
| increase | | | | |

### Example 4

Indented, flat glass test panels cleaned with the “potassium hydroxide/acid” cleaning regime in accordance with example 1 and coated with a coating combination comprising a silane solution comprising the silane coupling agent, gama-methacryloxypropyltrimethoxysilane 3% and the polyalkoxyfunctional silane crosslinker bis(tri-ethoxysilyl)ethane 3% in isopropanol solvent 13% in combination with an acrylate component comprising the acrylates and methacrylates: urethane methacrylate oligomer CN1963 48%, polyethylene glycol 600 dimethacrylate 8%, ethoxylated 2 bisphenol A dimethacrylate 8%, 2-hydroxyethyl methacrylate 8%, and trimethylolpropane triacrylate 4% along with photoinitiators 2-hydroxy-2-methyl-1-phenyl-1-proponane 1% and ethyl(2,4,6-trimethylbenzoyl)phenylphosphinate 3%. The ratio of total silane solution to total acrylate solution on a weight basis was 1 to 4. Water 1% adjusted to pH=4 with aqueous acetic acid was added to the silane component to catalytically hydrolyze the silane. Before mixing the silane solution with the acrylate solution, the silane solution was aged for 4 hours to promote prehydrolysis. The coating combination was applied to flat glass test panels via a blade coater to provide a coating thickness of 70 microns (Sample 3). The coating combination was modified by further including either 1% weight Tinuvin 292 (a hindered amine light stabilizer available from Ciba), Sample 4 (70 microns thick) or 4% weight fumed silica treated with a methacrylsilane (Aerosil 711), Sample 5 (70 microns thick). Table 3 summarizes the results of strength testing for Samples 3, 4 and 5 before QUV testing. The results are averages for 9 replicate tests.

TABLE 3
Strength Testing

| Test System | Sample 3 | Sample 4 | Sample 5 |
|---|---|---|---|
| Note | Indented glass, 70- | Indented glass, | Indented glass, |
| | micron coating | 70-micron coating | 70-micron coating |
| Average | 27745 | 29745 | 30886 |
| strength, psi | | | |
| Strength | 236% | 261% | 274% |
| Increase | | | |

Samples 3, 4 and 5 were also exposed to accelerated weathering testing as described above. In the QUV accelerated weathering testing for Sample 3, the coated test panels began to show blistering in about 1.4 week and delamination in 5-8 weeks. For Samples 4 and 5, blisters did not form until weeks 9 and 8 respectively and no delamination at weeks 21 and 12 respectively was observed.

### Example 5

The strength of the QUV tested test panels of Examples 3 and 4 were measured via a ring-on ring test. Table 4 summarizes the results.

TABLE 4
Strength (psi) of different coatings before and after QUV
test. Strength was measured after 2-4 hr of drying after samples were
removed from QUV chamber.

| | | QUV test period | Strength after |
|---|---|---|---|
| Sample Index | Initial strength, psi | (week) | QUV test, psi |
| Sample 1 | 27608 | 2.7 | 24804* |
| Sample 2 | 26101 | 1.9 | 28616* |
| Sample 3 | 27745 | 3.4 | 18171 |
| Sample 4 | 29765 | 21 | 20944 |
| Sample 5 | 30886 | 12 | 22994 |

*(measured after 24 hr of drying)

The data in Table 4 shows that coatings in accordance with the present invention provide maintained strength after as much as 21 weeks of accelerated weathering testing. After 21 weeks of QUV test, the coated glass (Sample 4) still had 20944 psi strength, which is 70% of the strength of unweathered, coated glass. There is still 150% of strength improvement over the indented, non-coated glass (Control 1).

### Example 6

Test panels prepared in accordance with examples 1 and 4, Samples 1 and 3 were immersed in boiling water for 110 hours. The thickness of each sample ranged from 60-150 μm. The Sample 1 coating formed macro-cracks in regions with thickness larger than 83 μm (FIG. 4a), and it formed micro-cracks and blisters in the regions of 60-83 μm (FIG. 4b). In contrast, the Sample 3 coating did not have any macro-cracks when thickness was thicker than 83 μm and nor did it have any blisters (FIG. 4c).

### Example 7

Test panels prepared in accordance with Examples 1 and 4 above were exposed to a thermal cycling/humidity test that mimicked ASTM E773/E774 test. In the standard ASTM E773/E774 weathering test, coated glass undergoes a high humidity test first and then an accelerated weather cycle test (see Table 5). The latter includes freeze-thaw cycles, UV irradiation, and short water spray. The rating levels of this test, A, B and C levels, are determined according to how many times the coating can go through these cycled tests (as shown in Table 5) without property change. In the mimicked ASTM E773/E774 test, at each level, the coatings were first tested with QUV accelerated weathering test condition (60° C., continuous water spray, UVA irradiation at 0.25 W/m²/nm) to mimic the high humidity test (60° C., 95% relative humidity). Then the coatings were tested in a mimicked accelerated weather cycle test, i.e., the temperature profile of ASTM E773/E774 was followed with relative humidity increased to about 95% between hours 3 and 4 and maintained at 95% for one hour. There was no UV irradiation or water spray in the mimicked accelerated weather cycle test employed herein.

TABLE 5
Classification of A, B, C levels for Test Method E773 (from
ASTM E774).

| | Duration of the accelerated weathering test | |
|---|---|---|
| Classification of | High | Accelerated weather cycle test, |
| Specimen | humidity test, (days) | cycles (6 hr in each cycle) |
| Class C | 14 | 140 |
| Class B | 14 | 56 |
| Class A | 14 | 56 |

Samples 1 through 5 as described above were exposed to the alternating high humidity and accelerated weather cycle test to determine a rating in accordance with Table 5. Table 6 summarizes the results.

TABLE 6
High Humidity/Accelerated Weather Cycle Testing

| Level | Test | Sample 1 | Sample 2 | Sample 3 | Sample 4 | Sample 5 |
|---|---|---|---|---|---|---|
| Class C | High humidity | some blisters | some blisters | some blisters | OK | OK |
| | Accelerated | some bright spots | some blisters | some bright spots | OK | OK |
| | weather cycle | | | | | |
| Class B | High humidity | delaminated | delaminateed | delaminated | OK | OK |
| | Accelerated | n/a | n/a | n/a | OK | OK |
| | weather cycle | | | | | |
| Class A | High humidity | n/a | n/a | n/a | minor blisters | big blisters |
| | Accelerated | n/a | n/a | n/a | minor blisters | severe cracks |
| | weather cycle | | | | | |

At the class C test, Samples 1 and 2 coatings (70 microns and 30 microns respectively) and Sample 3 (70 microns) coatings started to form blisters right after the high humidity test (QUV test). The blisters actually recovered to some extent during the five-week (140 cycles) accelerated weather cycle test and changed into bright spots. Samples 4 and 5 remained perfect at the Class C level.

At class B, Samples 1, 2 and 3 coatings started to delaminate after the high humidity test (QUV test). Samples 4 and 5 were both fine at Class B. This result is consistent with their performance in the QUV test.

At class A, after the high humidity test, there were big blisters formed in the Sample 5 coating, whereas there were only minor blisters formed in Sample 4 coating. Then after the two-week (56 cycles) thermal cycling test at class A, there were severe cracks formed in the Sample 5 coating, but the Sample 4 coating remained intact.

In the Sample 4 coating, after the class A test, the coating remained adhered to the glass substrate. Under optical microscope, no severe blisters were observed.

### Example 8

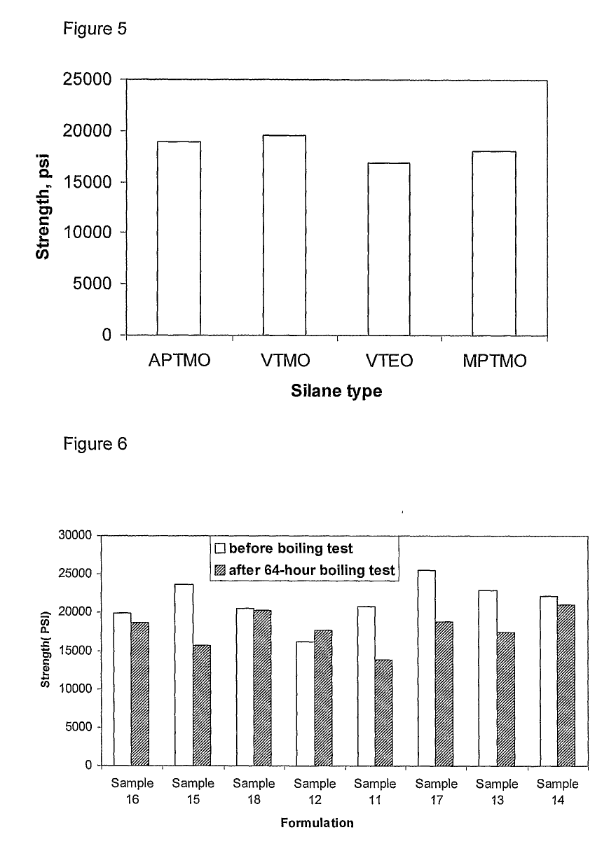

The silanes acryloxypropyltrimethoxysilane (APTMO), vinyltrimethoxysilane (VTMO), vinyltriethoxysilane (VTEO), and γ-methacryloxypropyltrimethoxysilane (MPTMO) were combined with the acrylates and photoiniator as set out in table 7. Before mixing the silane solution (silane plus isopropanol) with the acrylate solution, the silane solution (including silane, water, and isopropanol) was aged for one day. The glass samples were cleaned with the commercial glass cleaner regime described above. The formulation was applied to the edges of flat glass panels via a motored, “V” shape roller applicator. Infrared panels were used to heat each glass edge (for 20 seconds) to reach a surface temperature of 120-140° C. Then the coating was cured by UV irradiation. The strength was tested via the four-point bending method. FIG. 5 summarizes the results.

TABLE 7

| ingredients | APTMO | VTMO | VTEO | MPTMO |
|---|---|---|---|---|
| Urethance acrylate oliogmer | 49% | 49% | 49% | 49% |
| CN963A80 | | | | |
| Pentaerythritol tetraacrylate | 10% | 10% | 10% | 10% |
| Trimethyloylpropane | 15% | 15% | 15% | 15% |
| triacrylate | | | | |
| Isobornyl acrylate | 10% | 10% | 10% | 10% |
| Photoinitiator Irgacure 184 | 3% | 3% | 3% | 3% |
| silane | 6% | 5% | 5% | 6% |
| water (pH = 4) | 1% | 2% | 2% | 1% |
| Isopropanol | 7% | 7% | 7% | 7% |

### Example 9

Four aliphatic polyester urethane acrylate oligomers (including those mixed with small amount of acrylate monomers) Ebecryl284, CN983, CN963A80, and CN991 were each diluted with 1,6-hexanediol dimethacrylate (HDDMA) at 4:1 ratio. Photoinitiators 2-hydroxy-2-methyl-1-phenyl-1-proponane and ethyl(2,4,6-trimethylbenzoyl)phenylphosphinate were added at concentrations of 1 PPH (parts per hundred) and 4 PPH respectively. Each solution was then added to a silane solution, which had been aged for four hours, of gama-methacryloxypropyltrimethoxysilane 15%, bis(tri-ethoxysilyl)ethane 15% and water 5% in isopropanol solvent 65% at a 4:1 ratio of acrylate solution to silane solution to prepare a coating solution.

Coatings of about 40 μm thick were applied to the surface of glass cleaned with the “potassium hydroxide/acid” cleaning regime via a blade coater and then exposed to the boiling water test. After seven hours of immersion, only the coating formulated with Ebecryl284 did not form blisters. All other three coatings, which were formulated with CN983, CN963A80, and CN991 led to severe blister formation.

### Example 10

The silane formulation, aged for four hours, of example I was combined with the acrylates set forth in table 8. Glass articles (1 in by 6 in) were cleaned by the Windex regime. The coatings were applied to glass edge and the initial strength was measured by four-point bending test. QUV accelerated testing as described above was conducted to determine when the coatings delaminated. Table 8 lists the formulation of the radiation curable acrylate part and summarizes the results.

TABLE 8

| | Tris(2-hydroxy | | Urethane acrylate | 2-hydroxy-2- | | | Weeks to |
|---|---|---|---|---|---|---|---|
| | ethyl) | di- | oligomer plus | methyl-1- | | Initial | delamiante |
| Isobornyl | isocyanurate | trimethylolpropane | hexanediol diacrylate | phenyl-1- | ethyl(2,4,6- | Strength, | in QUV |
| acrylate | triacrylate | tetraacrylate | (Ebecryl284) | proponane | trimethylbenzoyl)phenylphosphinate | psi | test |
| 9 | 55 | 0 | 30 | 2 | 4 | 14800 | 11 |
| 36 | 34 | 0 | 23 | 4 | 4 | 15000 | 11 |
| 36 | 18 | 0 | 41 | 1 | 4 | 12500 | 8 |
| 36 | 37 | 0 | 23 | 2 | 2 | 15100 | 8 |
| 20 | 55 | 0 | 23 | 1 | 2 | 17600 | 9 |
| 9 | 38 | 27 | 23 | 1 | 2 | 15500 | 9 |
| 21 | 35 | 0 | 37 | 1 | 5 | 14500 | 11 |
| 9 | 55 | 0 | 31 | 4 | 2 | 13800 | 11 |
| 9 | 34 | 0 | 55 | 1 | 2 | 15100 | 11 |
| 18 | 18 | 0 | 55 | 4 | 5 | 13600 | 9 |
| 36 | 34 | 0 | 23 | 4 | 4 | 14500 | 10 |

### Example 11

The silane formulation, aged for four hours, of example I was combined with the acrylate compositions set forth in weight percent in table 9. Glass articles were cleaned by the KOH/acid regime. Coatings were applied to indented, cleaned glass surface via a blade coater. The thickness of coating after drying and curing was 100 microns. Both the initial strength and the strength after 64 hours of boiling water immersion were measured by the ring-on-ring test. FIG. 6 summarizes the results.

TABLE 9

| | | | | Urethane |
|---|---|---|---|---|
| | Polyethylene | Ethoxylated 2 | 2- | methacrylate |
| | glycol (600) | Bisphenol A | hydroxyethyl | oliogmer |
| | dimethacrylate | dimethacrylate | methacrylate | CN1963 |
| Sample 11 | 0 | 0 | 10 | 80 |
| Sample 12 | 10 | 10 | 0 | 70 |
| Sample 13 | 0 | 10 | 10 | 70 |
| Sample 14 | 10 | 10 | 10 | 60 |
| Sample 15 | 10 | 0 | 0 | 80 |
| Sample 16 | 0 | 0 | 0 | 90 |
| Sample 17 | 10 | 0 | 10 | 70 |
| Sample 18 | 0 | 10 | 0 | 80 |

### COMPARATIVE EXAMPLES

Glass substrates were cleaned with the potassium hydroxide/acid cleaning regime described in Example 1. A silane solution of 0.5% by weight methacryloxypropyl-trimethoxysilane (MPTMO) in a 50% water/50% isopropanol solvent adjusted to pH 4.5 with acetic acid was prepared. For Comparative Samples 1 and 2, cleaned glass substrates were immersed in the silane solution and drie a polyalkoxyfunctional silane crosslinker having four or more alkoxy groups d at 60° C. for 2 minutes. Thereafter reactive acrylate solutions as set out in Table 7 were applied to the glass substrates. The acrylate solutions include photoinitiators Darcour 1173 and Lucirin TPO-L. A blade coater was used to apply the coatings. Then the coatings were dried in an oven at 60° C. for 1 minute. After drying, the coatings were cured via exposure to an ultraviolet lamp. The thickness of the cured coatings were about 70 microns. The coated glass substrates were subjected to the boiling water test described above. Comparative Samples 3 and 4 were not “pretreated” with the silane solution, but rather, the silane MPTMO was added directly to the reactive-acrylate solutions as described in Table 7. The reactive acrylate solutions were applied with the same blade coating method, and then dried and cured the same way. Comparative Samples 3 and 4 were exposed to the same boiling water testing after application of the coating. The data in Table 7 shows that glass substrates treated with a silane coupling agent pretreatment and a reactive acrylate solution cured with ultraviolet light, Comparative samples 1 and 2, exhibited a time to delamination of less than 26 hours in the boiling water test. Comparative samples 3 and 4, where the silane was applied in the reactive acrylate solution, exhibited similar or shorter times to delamination. Coatings comprising a silane solution and a radiation curable acrylate solution in accordance with the present invention (Samples 2, 3 and 4) exhibited times to delamination of greater than 50 or 100 hours.

TABLE 7
Comparative tests

| | Substrate | | | Boiling water |
|---|---|---|---|---|
| | pretreatment | Coating Formulation | | test (peeling |
| Test system | with silane | Ingredient | parts | time, hours) |
| Comparative | Yes | ethoxylated(4) bisphenol A diacrylate | 40.0 | <26 |
| Sample 1 | | 2-hydroxy propyl acrylate | 10.0 | |
| | | Neopentyl glycol diacrylate | 10.0 | |
| | | trimethylolpropane triacrylate | 15.0 | |
| | | dipentaerythritol hexaacrylate | 15.9 | |
| | | tetrahydrofurfuryl acrylate | 5.0 | |
| | | Darocur1173 | 1 | |
| | | Lucirin TPO-L | 3 | |
| Comparative | Yes | ethoxylated(4) bisphenol A diacrylate | 40.0 | <26 |
| Sample 2 | | tripropylene glycol diacrylate | 10 | |
| | | Neopentyl glycol diacrylate | 10 | |
| | | trimethylolpropane triacrylate | 15 | |
| | | dipentaerythritol hexaacrylate | 15.9 | |
| | | tetrahydrofurfuryl acrylate | 5 | |
| | | Darocur1173 | 1 | |
| | | Lucirin TPO-L | 3 | |
| Comparative | No | ethoxylated(4) bisphenol A diacrylate | 40 | <26 |
| Sample 3 | | 2-hydroxy propyl acrylate | 10 | |
| | | Neopentyl glycol diacrylate | 10 | |
| | | trimethylolpropane triacrylate | 15 | |
| | | dipentaerythritol hexaacrylate | 10.9 | |
| | | tetrahydrofurfuryl acrylate | 5 | |
| | | Darocur1173 | 1 | |
| | | Lucirin TPO-L | 3 | |
| | | MPTMO | 5 | |
| Comparative | No | ethoxylated(4) bisphenol A diacrylate | 40 | 9 |
| Sample 4 | | tripropylene glycol diacrylate | 10 | |
| | | Neopentyl glycol diacrylate | 10 | |
| | | trimethylolpropane triacrylate | 15 | |
| | | dipentaerythritol hexaacrylate | 10.9 | |
| | | tetrahydrofurfuryl acrylate | 5 | |
| | | Darocur1173 | 1 | |
| | | Lucirin TPO-L | 3 | |
| | | MPTMO | 5 | |
| | | p-toluenesulfonic acid.H2O | 0.06 | |
| Sample 2 | No | | | >50 |
| Sample 3 | No | | | >100 |
| Sample 4 | No | | | >100 |

While the present invention has been described with respect to particular embodiments thereof, it is apparent that numerous other forms and modifications of the invention will be obvious to those skilled in the art. The appended claims and this invention generally should be construed to cover all such obvious forms and modifications that are within the true spirit and scope of the present invention.

1. A method of strengthening a brittle oxide substrate comprising the steps of:
a) cleaning a brittle oxide substrate,
b) thereafter contacting the brittle oxide surface with a coating solution comprising a silane coupling agent, a polyalkoxyfunctional silane crosslinker having four or more alkoxy groups and a radiation curable acrylate,
c) thereafter curing said coating solution.

2. The method of claim 1 wherein said cleaning comprises:
a) contacting the brittle oxide surface with a solution comprising saturated potassium hydroxide in isopropanol,
b) thereafter contacting the brittle oxide surface with acid,
c) thereafter rinsing the brittle oxide surface with water, and
d) drying the brittle oxide surface.

3. The method as claimed in claim 1 wherein said coating solution is dissolved in a non-aqueous solvent.

4. The method as claimed in claim 1 wherein said non-aqueous solvent is selected from the group ethanol, isopropanol, butanol, furfuryl alcohol, tetrahydrofuran, dioxane, diethyl ether, acetone, methylethylketone, methylisobutylketone, diethyl ether, methyl acetate, ethyl acetate, toluene, carbon tetrachloride, chloroform, n-hexane, dimethylformamide, and N-methyl-2-pyrrolidone.

5. The method as claimed in claim 1 wherein said silane coupling agent is selected from the group consisting of γ-methacryloxypropyl-trimethoxysilane, γ-acryloxypropyltrimethoxysilane, γ-acryloxypropyltriethoxysilane, methacryloxypropyltriethoxysilane, methacryloxymethyltriethoxysilane, methacryloxymethyltrimethoxysilane, vinyltrimethoxysilane, vinyltriethoxysilane, vinyltris(2-methoxyethoxy)silane, vinyltriisopropoxysilane, vinyltriacetoxy silane, allyltrimethoxysilane, allyltriethoxysilane, and mixtures thereof.

6. The method as claimed in claim 1 wherein the weight ratio of silane coupling agent to polyalkoxyfunctional silane crosslinker is from about 1 to 2 to about 10 to 1.

7. The method as claimed in claim 1 wherein said silane coupling agent and said polyalkoxyfunctional silane crosslinker comprise from about 1 to 10% by weight of said coating solution after drying.

8. The method as claimed in claim 1 wherein the polyalkoxyfunctional silane crosslinker is selected from the group consisting of bis(triethoxysilyl)ethane, bis(trimethoxysilyl)ethane, tris(trimethoxysilylpropyl)isocyanurate and mixtures thereof.

9. The method as claimed in claim 1 wherein said radiation curable acrylate is selected form the group consisting of acrylate monomers, methacrylate monomers, acrylate oligomers, methacrylate oligomers and mixtures thereof.

10. The method as claimed in claim 1 wherein said radiation curable acrylate is selected from the group consisting of isobornyl acrylate, 2-hydroxyethyl methacrylate, 1,6-hexanediol diacrylate, polyethylene glycol 600 dimethacrylate, ethoxylated 2 bisphenol A dimethacrylate, trimethylolpropane triacrylate, tris(hydroxyethyl)isocyanurate triacrylate, di-trimethylolpropane tetraacrylate, pentaerythritol triacrylate, pentaerythritol tetraacrylate, aliphatic urethane acrylate oligomer, urethane methacrylate oligomer and mixtures thereof.

11. The method as claimed in claim 1 wherein said coating solution further comprises a photoinitiator.

12. The method as claimed in claim 1 wherein said coating solution further comprises a hindered amine light stabilizer.

13. The method as claimed in claim 1 wherein said coating solution further comprises inorganic particles.

14. The method as claimed in claim 1 wherein said curing is via ultraviolet light or heating or a combination thereof.

15. A brittle oxide article coated via the method as claimed in claim 1.

16. A curable composition comprising a silane coupling agent, a polyalkoxyfunctional silane crosslinker having four or more alkoxy groups, a radiation curable acrylate and an initiator in non-aqueous solvent.

17. The curable composition of claim 16 wherein said silane coupling agent is selected from the group consisting of γ-methacryloxypropyl-trimethoxysilane, γ-acryloxypropyltrimethoxysilane, γ-acryloxypropyltriethoxysilane, methacryloxypropyltriethoxysilane, methacryloxymethyltriethoxysilane, methacryloxymethyltrimethoxysilane, vinyltrimethoxysilane, vinyltriethoxysilane, vinyltris(2-methoxyethoxy)silane, vinyltriisopropoxysilane, vinyltriacetoxy silane, allyltrimethoxysilane, allyltriethoxysilane, and mixtures thereof.

18. The curable composition of claim 16 wherein said polyalkoxyfunctional silane crosslinker is selected from the group consisting of bis(triethoxysilyl)ethane, bis(trimethoxysilyl)ethane, tris(trimethoxysilylpropyl)isocyanurate and mixtures thereof.

19. The curable composition of claim 16 wherein the weight ratio of silane coupling agent to polyalkoxyfunctional silane crosslinker is from about 1 to 2 to about 10 to 1.

20. The curable composition of claim 16 wherein said silane coupling agent and said polyalkoxyfunctional silane crosslinker comprise from about 1 to 10% by weight of said curable composition.

21. The curable composition of claim 16 wherein said non-aqueous solvent is selected from the group ethanol, isopropanol, butanol, furfuryl alcohol, tetrahydrofuran, dioxane, diethyl ether, acetone, methylethylketone, methylisobutylketone, diethyl ether, methyl acetate, ethyl acetate, toluene, carbon tetrachloride, chloroform, n-hexane, dimethylformamide, and N-methyl-2-pyrrolidone.

22. The curable composition of claim 16 wherein said radiation curable acrylate is selected from the group consisting of acrylate monomers, methacrylate monomers, acrylate oligomers, methacrylate oligomers and mixtures thereof.

23. The curable composition claim 16 wherein said radiation curable acrylate is selected from the group consisting of isobornyl acrylate, 2-hydroxyethyl methacrylate, 1,6-hexanediol diacrylate, polyethylene glycol 600 dimethacrylate, ethoxylated 2 bisphenol A dimethacrylate, trimethylolpropane triacrylate, tris(hydroxyethyl)isocyanurate triacrylate, di-trimethylolpropane tetraacrylate, pentaerythritol triacrylate, pentaerythritol tetraacrylate, aliphatic urethane acrylate oligomer, urethane methacrylate oligomer and mixtures thereof.

24. The curable composition of claim 16 wherein said initiator is selected form the group photoinitiators, thermal initiators and mixtures thereof.

25. The curable composition of claim 16 wherein said curable composition further comprises a hindered amine light stabilizer.

26. The curable composition of claim 16 wherein said curable composition further comprises inorganic particles.
